(19) United States
(12) Patent Application Publication
(10) Pub. No.: US 2024/0181452 A1
(43) Pub. Date: Jun. 6, 2024

(54) MICROFLUIDIC SYSTEM

(71) Applicant: miDiagnostics NV, Heverlee (BE)

(72) Inventor: David Mikaelian, Heverlee (BE)

(21) Appl. No.: 18/556,209

(22) PCT Filed: Apr. 20, 2022
(86) PCT No.: PCT/EP2022/060421

§ 371 Date: Oct. 19, 2023

(30) Foreign Application Priority Data
Apr. 20, 2021 (EP) 21169487.2

(51) Int. Cl. B01L 3/00

(52) U.S. Cl. CPC B01L 3/50273; B01L 2200/0684; B01L 2300/161; B01L 2400/0406; B01L 2400/0688; B01L 2400/084

(57) ABSTRACT

The present inventive concept relates to a microfluidic system for compensation of evaporation of liquid from channels. The microfluidic system comprises: a compensating microfluidic channel having a first end arranged for hindering capillary driven flow of a liquid out from the compensation microfluidic channel via the first end, and, a second end, being connected to a first microfluidic channel: a sample manipulation portion comprising a plurality of outlet channels, wherein each outlet channel ends in a respective stop valve, wherein the first microfluidic channel connects to the sample manipulation portion, thereby being in fluidic connection with the plurality of outlet channels, wherein each outlet channel of the plurality of outlet channels is arranged to exert a retention capillary pressure on the liquid, wherein the compensating microfluidic channel is arranged to exert a retention capillary pressure on the liquid, wherein the retention capillary pressure of each outlet channel is larger than the retention capillary pressure of the compensating microfluidic channel, such that the liquid flows from the compensating microfluidic channel towards the sample manipulation portion if liquid evaporates from one or more of the plurality of outlet channels at the respective stop valve, thereby compensating for evaporation of the liquid from the plurality of outlet channels at the respective stop valve.

### TECHNICAL FIELD

The present invention relates to a microfluidic system for compensation of evaporation of liquid from channels. The present invention further relates to a diagnostic device comprising the microfluidic system.

### BACKGROUND

Microfluidic systems, such as micro-total analysis systems, and miniaturized point-of-care devices have gained increasing interest over the last decades. Such systems typically may involve benefit including rapid analysis response at the point of sampling and enabling analysis even away from analytical laboratories or hospitals. Microfluidic systems and point-of-care devices may be used in analysis of biological samples or liquids, such as blood samples, including whole blood.

Analysis, handling and treating of liquid samples, such as aqueous samples, for example blood samples, in miniaturised systems is troublesome since liquids normally evaporates quickly when exposed to air. Such evaporation may lead to failure in microfluidic systems. For example, air entering microfluidic channels can result in termination of flows and/or disturbance in detection. Further precipitation or even crust formation may occur in samples subjected to evaporation, which may be particularly problematic for biological samples such as blood samples. Other problems associated with evaporation from samples, and particularly for the minute sample volumes often associated with microfluidic systems may be a reduced sample volume, which may result in decreased accuracy of, or even erroneous, analytical results, particularly so if the expected accuracy of analysis depends on a precisely measured sample volume.

Solutions to overcome problems associated with evaporation of sample liquid include avoiding of evaporation by saturation of surrounding air with liquid, or isolating the sample liquid from ambient air. However, such solutions suffer from being difficult to control and not viable for easy-to-use point-of-care devices, in particular for use under varying conditions or environments.

There is, thus, a need to provide microfluidic systems with reduced problems associated with evaporation of liquid from the systems, not just concerning blood samples, but many type of liquid samples or samples in solution.

### SUMMARY OF INVENTION

It is an object to mitigate, alleviate or eliminate one or more of the above-identified deficiencies in the art and disadvantages singly or in any combination and solve at least one above indicated problem.

According to a first aspect of the present inventive concept, there is provided a microfluidic system for compensation of evaporation of liquid from channels. The microfluidic system comprises: a compensating microfluidic channel having a first end arranged for hindering capillary driven flow of a liquid out from the compensation microfluidic channel via the first end, and, a second end, being connected to a first microfluidic channel; a sample manipulation portion comprising a plurality of outlet channels, wherein each outlet channel ends in a respective stop valve, wherein the first microfluidic channel connects to the sample manipulation portion, thereby being in fluidic connection with the plurality of outlet channels, wherein each outlet channel of the plurality of outlet channels is arranged to exert a retention capillary pressure on the liquid, wherein the compensating microfluidic channel is arranged to exert a retention capillary pressure on the liquid, wherein the retention capillary pressure of each outlet channel is larger than the retention capillary pressure of the compensating microfluidic channel, such that the liquid flows from the compensating microfluidic channel towards the sample manipulation portion if liquid evaporates from one or more of the plurality of outlet channels at the respective stop valve, thereby compensating for evaporation of the liquid from the plurality of outlet channels at the respective stop valve.

By means of the present microfluidic system, evaporation from openings, such as capillary stop valves, may be compensated by liquid from a compensating channel. Thereby, air intrusion at openings, such as at stop valves, can be avoided, and interruption or termination of capillary flows can be avoided or mitigated. With the present microfluidic system evaporation from openings may be compensated for passively, i.e. without need of pumps or intervention by a user of the system. It is further beneficial with the present inventive concept that evaporation from anywhere in the microfluidic system may be compensated for. For example, it may relate to openings towards the aimbient surroundings outside of the system, or it may relate to any interface with gaseous medium, for example within the system, such as, for example, at a capillary trigger valve, which may be the case where one of the stop valves is a capillary trigger valve.

According to a second aspect of the present inventive concept there is provided a diagnostic device comprising the microfluidic system of the first aspect.

According to a third aspect of the present inventive concept there is provided a method for compensating evaporation of liquid from channels in a microfluidic system. The method comprises: providing liquid to a sample inlet of a second microfluidic channel, whereby the second microfluidic channel draws liquid, by capillary action, from the sample inlet to fill the second microfluidic channel; drawing liquid, by capillary action, from the second microfluidic channel into a compensating microfluidic channel and a first microfluidic channel, the compensating microfluidic channel and the first microfluidic channel branching off from the second microfluidic channel; drawing liquid, by capillary action, from the first microfluidic channel into a plurality of outlet channels of a sample manipulation portion, wherein each outlet channel ends in a respective stop valve; halting the liquid at the respective stop valve; wherein the compensating microfluidic channel exerts a retention capillary pressure on the liquid, and wherein each outlet channel of the plurality of outlet channels exerts a retention capillary pressure on the liquid, each retention capillary pressure of the plurality of outlet channels being larger than the retention capillary pressure of the compensating microfluidic channel; and flowing liquid from the compensating microfluidic channel towards the sample manipulation portion in response to liquid evaporating from one or more of the plurality of outlet channels at the respective stop valve, thereby compensating for evaporation of the liquid from the plurality of outlet channels at the respective stop valve.

The method according to the third aspect may be implemented using a microfluidic system according to the first aspect and embodiments thereof. References to the first aspect and embodiments are hereby made.

### BRIEF DESCRIPTION OF THE DRAWINGS

The above and other aspects of the present inventive concept will now be described in more detail, with reference to appended drawings showing variants of the invention. The figures should not be considered limiting the invention to the specific variant; instead they are used for explaining and understanding the inventive concept.

As illustrated in the figures, sizes of components, such as channels, and regions may be exaggerated for illustrative purposes and, thus, be provided to illustrate the general structures of variants of the present inventive concept. Like reference numerals refer to like elements throughout.

FIG. 1 illustrates a microfluidic system according to embodiments.

FIG. 2 illustrates a microfluidic system according to embodiments.

FIGS. 3A and 3B illustrates compensation of evaporation according to embodiments.

FIGS. 4A and 4B illustrates problems associated with evaporation from a comparative system.

FIGS. 5A and 5B illustrates compensation of evaporation according to embodiments.

FIG. 6 illustrates an embodiment of an aspect.

FIG. 7 illustrates a method.

### DETAILED DESCRIPTION

The present inventive concept will now be described more fully hereinafter with reference to the accompanying drawings, in which variants of the inventive concept are shown. The inventive concepts may, however, be implemented in many different forms and should not be construed as limited to the variants set forth herein; rather, these variants are provided for thoroughness and completeness, and fully convey the scope of the present inventive concept to the skilled person.

It is to be understood that at least the first microfluidic channel, the second microfluidic channel, the compensating microfluidic channel and the outlet channels are capillary channels. A capillary channel is a channel capable of providing a capillary-driven flow of a liquid. It is also to be understood that other channels and components of the system may be capillary channels and/or other types of channels depending on the specific implementation of the present inventive concept. Although a capillary channel is capable of providing a capillary-driven flow of a liquid, it is not excluded that other types of transport or forwarding of liquids may be used with the microfluidic channels. For example, pressure-assisted flows may be employed.

In the following, liquid may flow through channels and reach certain positions at different times within the microfluidic system. Flow rates of flows may be controlled in different manners in order for the fluid to reach the positions at the described times. A capillary-driven flow of a fluid requires one or more contacting surfaces that the fluid can wet. For example, surfaces comprising glass or silica may be used for capillary-driven flows of aqueous liquids. Further, for example, suitable polymers with hydrophilic properties, either inherent to the polymer or by modification, including for example chemical modification or coating, may promote or enhance capillary driven flows. Capillary-driven flows, in addition to being dependent on materials of surfaces, is dependent on the liquid flowing. Attractive forces between the liquid and surfaces of channels have effect on a capillary-driven flow.

Further, capillary-driven flows may be controlled, for example, by adapting dimensions, including length, width and depth, of the channels and/or by adapting the flow resistances of the channels, and/or by adapting capillary driving forces or pressures. For example, the flow resistance of a channel may be controlled by adapting a cross-sectional area of the channel and/or the length of the channel. The flow resistance of a channel may, as indicated above, further be dependent on properties of the liquid, e.g. its dynamic viscosity. Additionally, or alternatively, the flow rate may be adapted by using flow resistors, for example flow resistors in a flow path of the liquid. A flow resistor may be a channel with a defined flow resistance in a flow path of the liquid.

To provide desired capillary forces, dimensions of flow channels may be selected dependent on, for example, the liquid and properties of the liquid and/or material and/or properties of walls of the channels.

Capillary pressure may be generated when an interface is present between two fluids and is a function of the geometry of the channel, the surface properties and the two fluids. Capillary pressure, such as retention capillary pressure may be determined, for example by calculation. As one example, a capillary pressure in a rectangular cross section channel may be calculated for a liquid according to equation (1):

$$Δ P = γ ( \frac{2}{{w}_{c}} + \frac{2}{{h}_{c}} ) cos ( θ ) , \qquad ( equation ( 1 ) )$$

wherein γ is the surface tension coefficient of the liquid with a gas phase, for example about 0.072 N/m for water with air, w_{c} is the channel width, h_{c} is the channel height, and Θ is the contact angle of the liquid with the solid surfaces of the channel, for example, <90° for a hydrophilic material.

For example, water flowing in a 50 μm by 50 μm cross section channel with a contact angle of 45° yields a capillary pressure of about 4.1 kPa.

Typically, during normal use of a capillary channel or microfluidic channel of a system, the channel will be filled with liquid to a point where capillary driven flow of the liquid stops, i.e. often all the way up to the end of the respective channel, when liquid is dispensed in the system. The liquid may stop before reaching the end of the channel, such as if a portion of the channel has properties which stops the capillary driven flow before reaching the end of the channel. If no pull due to evaporation, the interface will stay flat where the capillary driven flow of the liquid stopped, eg. at the end of the channel. If a pull due to evaporation and if no liquid is available to refill the channel the interface will curve and start to recede in the channel. As used herein, retention capillary pressure may be described as the pressure necessary to create a receding interface that will move in a direction from the point where capillary driven flow of the liquid stopped towards a position from which the liquid came.

This retention capillary pressure may depend on the dimensions/geometries of the channel and/or and properties of the liquid and/or material and/or properties of the walls of the channels. For example, a (rectangular) channel with constant cross-section and surface properties of the walls along its length will have constant retention capillary pressure along its length for a given liquid. For example, a (rectangular) channel with constant cross-section and with sections with different surface properties of the walls along its length will have different retention capillary pressures for a given liquid in each of the sections.

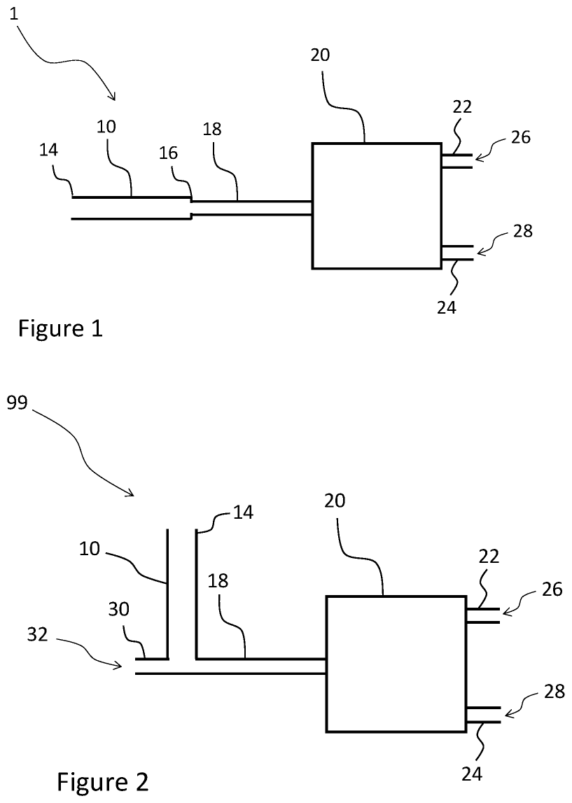

With reference to FIG. 1, a microfluidic system 1 for compensation of evaporation of liquid from channels will now be discussed. The microfluidic system 1 comprises: a compensating microfluidic channel 10 having a first end 14 arranged for hindering capillary driven flow of a liquid out from the compensation microfluidic 10 channel via the first end 14, and, a second end 16, being connected to a first microfluidic channel 18; a sample manipulation portion 20 comprising a plurality of outlet channels 22, 24, wherein each outlet channel 22, 24 ends in a respective stop valve 26, 28, wherein the first microfluidic channel 18 connects to the sample manipulation portion 20, thereby being in fluidic connection with the plurality of outlet channels 22, 24, wherein each outlet channel of the plurality of outlet channels 22, 24 is arranged to exert a retention capillary pressure on the liquid, wherein the compensating microfluidic channel 10 is arranged to exert a retention capillary pressure on the liquid, wherein the retention capillary pressure of each outlet channel is larger than the retention capillary pressure of the compensating microfluidic channel, such that the liquid flows from the compensating microfluidic channel 10 towards the sample manipulation portion 20 if liquid evaporates from one or more of the plurality of outlet channels 22, 24 at the respective stop valve 26, 28, thereby compensating for evaporation of the liquid from the plurality of outlet channels 22, 24 at the respective stop valve 26, 28.

Each outlet channel 22, 24 of the plurality of outlet channels 22, 24 may be arranged to exert a retention capillary pressure on the liquid at, or adjacent to, the end, or at the stop valve, of each and respective outlet channel 22, 24.

The compensating microfluidic channel 10 may be arranged to exert a retention capillary pressure on the liquid at the first end 14.

The compensating microfluidic channel may have a capillary stop portion arranged at the first end for hindering capillary driven flow of a liquid out from the compensation microfluidic channel via the first end. The capillary stop portion may be, for example, a capillary stop valve. Thus, for example, the first end 14 of the compensating microfluidic channel 10, 101 may be connected to a capillary stop valve, thereby arranged for hindering capillary driven flow of a liquid out from the compensation microfluidic channel 10 via the first end 14.

With considerations to the illustrated microfluidic system 1, assumed for the discussion herein below to have the microfluidic channels filled with liquid (not illustrated) such as aqueous liquid. If evaporation of the liquid occurs from one or more of the stop valves 26, 28 there will be exerted a capillary pressure at the one or more stop valves 26, 28 which is larger than the retention capillary pressure of the compensating microfluidic channel 10, on the liquid, which will result in liquid flowing from the compensating capillary channel 10 towards the one or more stop valves. This is a result of the retention capillary pressure of each outlet channel 26, 28 being larger than the retention capillary pressure of the compensating microfluidic channel. Thereby, entry of fluid or gas, such as air, ambient to the stop valves 26, 28 as replacement for liquid being evaporated can be avoided as a result of liquid from the compensating microfluidic channel 10 flowing towards the stop valves 26, 28. Ambient fluid, such as air, will instead enter the system 1 via the first end 14 at the compensating microfluidic channel 10 and replace void from liquid evaporated from the one or more stop valves 26, 28. Thereby, air bubbles can efficiently be avoided at the one or more outlet channels 22, 24, and thereby air bubbles can be avoided to enter the system 1 outside of the compensating microfluidic channel, and/or disturb capillary flows at the one or more stop valves 26, 28.

The first end 14 of the compensating microfluidic channel 10 being arranged for hindering capillary driven flow of a liquid out from the compensation microfluidic 10 channel via the first end 14, may be realized for example by the compensating microfluidic channel 10 mouthing into a larger and/or deeper non capillary pressure generating portion. For example, mouthing into, or being connected to, a sample or buffer liquid reservoir. The compensating microfluidic channel may also be simply a cut of microfluidic capillary tubing or arranged in another fashion to stop capillary flow out from the first end 14.

The outlet channels 22, 24 have been schematically illustrated as having smaller dimensions as compared to the compensating microfluidic channel 10, which may be one way of providing the desired retention capillary pressures. It will be appreciated that the channels may have similar dimensions over a major portion of the capillary lengths, but that the terminating portions of the outlet channels 22, 24 may be eg. narrower, thus exerting or providing larger capillary pressures as compared to the compensating microfluidic channel 10. It shall be realized and appreciated, that other properties than channel dimensions may have an effect on capillary retention pressures, such eg. properties relating to the liquid, or materials of channel walls, to mention some examples. For example, the outlet channels 22, 24 may be fabricated from more hydrophilic material as compared to the material of the compensating microfluidic channel 10.

The sample manipulation portion 20 may comprise any suitable type of sample manipulation, including, for example, sample transport, sample metering, sample manipulation by reaction, sample sorting or sample analysis. Thus, sample manipulation, as used herein, may, for example, involve forwarding of a liquid or sample in the sample manipulation portion 20, such as by capillary driven flowing. The sample manipulation does not have to, although it may, involve transformation, such as via reaction, of the sample.

The microfluidic system may function with other type of liquids than sample liquid.

Suitable dimensions of microfluidic channels and outlet channels of the system may be selected. Typical cross-sections of channels, as seen along a flow direction of the channel, will now be exemplified. For example, eg. concerning a channel having a rectangular cross-section, cross-sections of the microfluidic channels and outlet channels may have a dimension, such as a height of a channel, between 5 μm and 3 mm, and may have another dimension, such as a width of a channel, between 5 μm and 3 mm. The cross-section may have any suitable shape, for example a circular cross-section, which may have a dimension, or a diameter, between 5 μm and 3 mm. If a channel has a rectangular cross-section, one dimension, such as a height of the cross-section may be selected to provide capillary driven flow, such as having a dimension of, for example, 5 μm to 1 mm, while the other another dimension of the cross-section may be selected being larger, such as, for example, having a dimension between 1 and 3 mm. Lengths of channels may be selected to suit its purpose. Typical lengths may be, for example, from 10 μm and up to 1 meter, such as from 10 μm to 10 mm.

The compensating microfluidic channel may comprise a sample inlet at the first end. For example, a microfluidic system 1 as illustrated and discussed with reference to FIG. 1 may have the first end 14 acting as a sample inlet. For example, the sample inlet may be in fluidic connection with a sample reservoir, such as by mouthing into the sample reservoir, which sample reservoir also may be part of the system 1. The sample reservoir may be a compartment or reservoir of eg. a chip which do not exert a capillary driven suction force on liquid inside a channel of the system to which it is connected. For such a purpose, the sample reservoir may be a relatively broad and deep structure, as compared to the microfluidic channels, and/or the sample reservoir may be coated with or made from material which reduces or minimizes capillary action on the liquid.

The liquid and/or sample liquid may be aqueous liquid, for example a solution in water.

With reference to FIG. 2, the microfluidic system 99 according to an example or embodiment will now be described. The microfluidic system 99 differs from a microfluidic system as described with reference to FIG. 1 for reasons including that the microfluidic system 1 further comprises a second microfluidic channel 30 comprising a sample inlet 32 arranged for introduction of sample liquid into the second microfluidic channel 32 and for hindering capillary driven flow of liquid out from the second microfluidic channel 30 via the sample inlet 32, the second microfluidic channel 30 branching off into the compensating microfluidic channel 10 and the first microfluidic channel 18.

Hindering capillary driven flow of liquid out from the second microfluidic channel 30 via the sample inlet 32 may be realized, for example, by a capillary stop valve, or other means of terminating capillary driven flows, such as according to examples described herein. Thus, the sample inlet 32 may be connected to a capillary stop valve, thereby arranged for hindering capillary driven flow of liquid out from the second microfluidic channel 30 via the sample inlet 32. As an alternative to a capillary stop valve, another non capillary pressure generating portion may be connected to the sample inlet 32. For example, this may be realised by the sample inlet 32 mouthing into a wider, thus capillary driven flow terminating, portion, such as, for example, by being connected to or mouthing into a liquid reservoir or well, such that capillary driven flow out of the sample inlet 32 is prevented or hindered.

When the microfluidic system 1 further comprises the second microfluidic channel 30, the second microfluidic channel may be arranged to exert a first retention capillary pressure on the liquid, and the first retention capillary pressure may be larger than the retention capillary pressure of the compensating microfluidic channel. Thereby, the liquid may flow from the compensating microfluidic channel 10 towards the second microfluidic channel 30 if the liquid evaporates from the sample inlet 32, thereby compensating for evaporation of the liquid from the second microfluidic channel 30 at the sample inlet 32.

An example or embodiment of the microfluidic system 1 illustrated with reference to FIG. 2 will now be further discussed. The microfluidic system 99 may, for example, function as follows: Sample liquid is provided, such as aqueous liquid, for example a blood sample. As the sample liquid is contacted with the sample inlet 32 of the second microfluidic channel 30, being a capillary channel, sample liquid may be introduced and forwarded via the sample inlet 32 into the second microfluidic channel 30 such as by means of capillary action, or generated pressure. The sample liquid will, when reaching the junction between the second 30, compensating 10 and first 18 microfluidic channels, enter and be forwarded into, by capillary action or generated pressure, the compensating microfluidic channel 10 and the first 18 microfluidic channel. In the compensating microfluidic channel 10 the sample liquid will, typically, proceed until the first end 14 of the compensating microfluidic channel is reached where the sample liquid will be hindered to flow out of the compensation microfluidic channel 10 having the first end 14 arranged for hindering capillary driven flow of a liquid out from the compensation microfluidic channel 10. The hindering may be realized, for example, by the first end 14 mouthing into or being terminated into a wider and/or deeper, or otherwise, non-capillary force generating portion, such as, for example, a reservoir. As an alternative to the first end 14 mouthing into or being terminated into a wider and/or deeper, or otherwise, non-capillary force generating portion, it may, for example, comprise or be connected with a portion having a surface coating which does not provide a capillary force for the liquid, such as sample liquid, in use, such as by not providing sufficient attractive forces between the coating and the sample liquid. The sample liquid will further, when reaching the junction, enter and be forwarded into, by capillary action or generated pressure, the first microfluidic channel 18. From the first microfluidic channel 18, the sample liquid may be forwarded, via sample manipulation portion 20, to and into the outlet channels 22, 24 where the sample liquid capillary flow will end at the respective stop valve 26, 28. The stop valves may act and function similar as was described concerning the first end 14 of the compensating microfluidic channel 10, or may be, for example a capillary trigger valve. It shall now be assumed that the system 99 is filled with sample liquid as has been described. It shall further be assumed that the sample liquid at each of the sample inlet 32, the first end 14 of the compensating microfluidic channel 10, and the stop valves 26, 28 are interfaced with gaseous medium, for example air. For a case where the sample inlet 32 of the second microfluidic channel 30 is connected to a sample reservoir from which sample liquid was introduced, the sample reservoir may have been emptied by means of a capillary pump or similar after sample introduction, thereby being filled with eg. air and providing the interface with gaseous medium. The liquid present within the channels and having an interface with gaseous medium at one or more of the first end 14 of the compensating microfluidic channel 10, the sample inlet 32 of the second microfluidic channel 30, and the stop valves 26, 28 of the outlet channels 22, 24, will typically be subjected to evaporation.

Now it shall be discussed and considered that the retention capillary pressure of each outlet channel 22, 24 and the first retention capillary pressure of the second microfluidic channel, may be larger than the retention capillary pressure of the compensating microfluidic channel. Thereby, if liquid is evaporated from any of the sample inlet 32 of the second microfluidic channel 30, and the stop valves 26, 28 of the outlet channels 22, 24, liquid bulk will be retained at those positions while losses resulting from evaporation will be compensated for by a flow of liquid from the compensating microfluidic channel 10, since the retention capillary pressure of the compensating microfluidic channel is lower than the retention capillary pressures of each outlet channel 22, 24. Thereby evaporation of the liquid from the sample inlet, and capillary stop valves (26, 28) will be compensated for. Any air pockets or air bubbles from evaporation will be comprised by and concentrated to the compensating microfluidic channel 10.

For some exemplary embodiments or examples, liquids termed ‘sample liquid’ or ‘liquid’ is described to be contained within the microfluidic system. Although it may be that one type of liquid is contained within the microfluidic system, alternatively several liquids or type of liquids may be contained within the microfluidic system. For example, one or more portions of the microfluidic system, such as channels or parts of channels, may be filled with eg. sample liquid and other one or more portions, such as channels or parts of channels, may be filled with other liquid, such as buffering liquids or other sample liquids. It may be desirable and even preferred for some applications that all liquid within the system is of similar type or have similar capillary pressure properties. For example, different liquids within the microfluidic system may be aqueous liquids, such as diluted water solutions associated with similar capillary force.

The microfluidic system, for example, as discussed with reference FIGS. 1 and 2 comprises the sample manipulation portion 20, which is illustrated as a schematic box not discussed in detail with reference to FIGS. 1 and 2. It shall be realized that the sample manipulation portion 20 may comprise several parts and details, such as, for example, microfluidic channels, valves and/or reservoirs, in fluidic connection with, for example, the outlet channels 22, 24 and/or the first microfluidic channel 18. In particular, the outlet channels 22, 24 may be in fluidic connection with the first microfluidic channel 18, directly, or via additional not illustrated microfluidic channels. Within or outside of the sample manipulation portion, the first microfluidic channel 18 may be connected to other microfluidic channels, such as by branching into other microfluidic channels.

Sample manipulation may be forwarding, without further manipulation or treatment, sample liquid to one or more of the outlet channels 22, 24 and the stop valves 26, 28

The plurality of outlet channels may comprise a first outlet microfluidic channel ending in a first stop valve, and a second outlet microfluidic channel ending in a second stop valve; wherein the first outlet microfluidic channel is arranged to exert a second retention capillary pressure on the liquid, and the second outlet microfluidic channel is arranged to exert a third retention capillary pressure on the liquid; wherein the second retention capillary pressure is larger than the retention capillary pressure of the compensating microfluidic channel, such that the liquid flows from the compensating microfluidic channel towards the first outlet microfluidic channel, if liquid evaporates from the first outlet microfluidic channels at the first stop valve, thereby compensating for evaporation of the liquid in the first outlet microfluidic channel at the first stop valve, and wherein the third capillary pressure is larger than the retention capillary pressure of the compensating microfluidic channel, such that the liquid flows from the compensating microfluidic channel towards the second outlet microfluidic channel, if liquid evaporates from the second outlet microfluidic channels at the second stop valve, thereby compensating for evaporation of the liquid in the second outlet microfluidic channel at the second stop valve.

A cross sectional area of the compensating microfluidic channel may be between 1.1 and 10, such as between 1.1 and 4 times, larger than a cross sectional area of the first outlet microfluidic channel adjacent to the first stop valve; and a cross sectional area of the compensating microfluidic channel may be between 1.1 and 10, such as between 1.1 and 4 times, larger than the cross sectional area of the second outlet microfluidic channel adjacent to the second stop valve. This may be one way of realizing the lower retention capillary pressure associated with the compensating microfluidic channel. It shall be realized and appreciated that other ways or means may be relevant in addition to or as alternatives to providing those relations between cross sectional areas. For example, the material or surface properties of the channels may be selected to provide desirable capillary pressures. To mention one example, the compensating microfluidic channel may have walls manufactured from or coated with material or compounds providing a lower capillary pressure of the liquid within. For example, the walls may have more hydrophobic properties than walls of the outlet channels or the second channel, optionally in combination with variations in cross-sectional areas. The compensating microfluidic channel may even have narrower dimensions, or a smaller cross-section, as compared to the outlets or channels adjacent to the outlets, if eg. properties still realize the lower retention capillary pressure associated with the compensating microfluidic channel.

Typically, the microfluidic system is intended to be used with the microfluidic channels filled with the liquid, and evaporation from the stop valves 26, 28 and optionally at sample inlet is compensated for via fluid from the compensating microfluidic channel 10. The retention capillary pressures of each of the outlet channels 22, 24 and of the second microfluidic channel may be determined by the retention capillary pressure at the end/outlet portions of the, respective, channel. For example, one or more of outlet channels and 22, 24 and second microfluidic channel 30 may be capillary channels being relatively wide but having a narrowing at the ends or at the inlet, thus providing or exerting relatively high retention capillary pressures when filled with liquid as compared to the retention capillary pressure of the compensating microfluidic channel, even though their dimensions may be eg. similar or larger over a major portion of the capillaries. The outlet channels and 22, 24 and second microfluidic channel 30 may also be described as channels having identical or similar cross-sectional areas over the length of the channel, thus having capillary pressure inside the channel similar to the pressure at the end portion.

The compensating microfluidic channel 10 may have a constant cross-sectional area as seen in a direction of the channel towards first end 14, or be adapted to exert a constant capillary pressure on the liquid, over a large or full length of the compensating microfluidic channel. Thereby, the compensating microfluidic channel may compensate for larger evaporation losses from eg. the stop valves or inlets and be less independent of the position of the liquid/gaseous interface within the compensating microfluidic channel. However, to provide compensation for less evaporation it may be sufficient that the compensating microfluidic channel has a cross-sectional area, or be adapted otherwise, at, or adjacent to, the first end 14 of the compensating microfluidic channel.

For example, the compensating microfluidic channel 10 may have a widening or enlarged cross-sectional area as seen in a direction of the channel towards the first end 14 of the compensating microfluidic channel while realizing the provision that the retention capillary pressure of each outlet channel 22, 24, and, where relevant, the second microfluidic channel, being larger than the retention capillary pressure of the compensating microfluidic channel. Such a compensating microfluidic channel 10, may however have a more limited compensating capacity than a similar channel without the widening or enlarged cross-sectional area, as the retention capillary pressure of the compensating microfluidic channel may increase and approach the retention pressures of the outlet channels 22, 24, as the level of liquid within the compensating microfluidic channel decreases.

The microfluidic system, when it is comprising a sample inlet, may further comprise a sample reservoir arranged for receiving sample fluid, wherein the sample reservoir is connected to the sample inlet. The sample reservoir may be configured essentially not to have a capillary action on liquid at the inlet.

The compensating microfluidic channel may be made of a first material, the first outlet microfluidic channel may be made of a second material, and the second outlet microfluidic channel may be made of the second material.

Thereby, capillary pressures may be designed or manipulated by selecting suitable first and second materials.

According to a second aspect of the present inventive concept there is provided a diagnostic device comprising the microfluidic system of the first aspect.

The diagnostic device may be arranged to analyse the sample liquid.

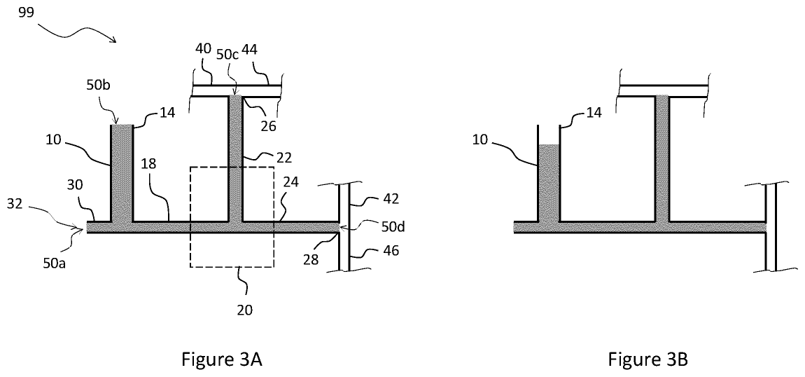

Benefits with the microfluidic system 1, 97, 99 will now further be discussed in view of exemplary embodiments, and with reference to FIGS. 3A to 5B. In an attempt to improve clarity and to simplify, the liquid is drawn without meniscuses at liquid-gas interface. Sample manipulation portion 20 is schematically indicated with box 20 in the figures. FIG. 3A illustrates a microfluidic system 99 according to an exemplary embodiment, as filled with liquid schematically illustrated as grey fields having entered the system 99 from sample inlet 32 of the illustrated second microfluidic channel 30. The compensating microfluidic channel 10 is illustrated together with the first end 14. The first microfluidic channel 18 has actuated, by capillary action, the liquid to the sample manipulation portion comprising the first outlet microfluidic channels 22 ending in a first stop valve 26; and the second outlet microfluidic channels 24 ending in a second stop valve 28. The first and second stop valves 26, 28 may, optionally, be trigger valves, for example, capillary trigger valves, which may be triggered by fluid entering the valves via trigger channels 40, 42, thereby allowing the liquid to flow out of the valve via valve outflow channels 44, 46. As illustrated, the liquid is stopped at first and second stop valves 26, 28. The liquid is subjected to evaporation at the liquid-gas interfaces present at the sample inlet 32, the first end 14 of the compensating microfluidic flow channel, and at the first and the second capillary stop valves, as indicated by arrows 50a to 50d. Evaporation from the sample inlet 32, and at the first and the second capillary stop valves, will not result in air entering from the ambiance at any of those interfaces as a result of the high retention capillary pressures provided there as compared to the retention capillary pressure of the compensating microfluidic channel. Instead, liquid evaporated therefrom will be compensated via liquid provided from the compensating microfluidic channel 10. Air will therefore enter the compensating microfluidic channel at the first end 14. FIG. 3B illustrates the system 99 as it may appear after a while of evaporation. Liquid volume has dropped in compensating microfluidic channel 10 while leaving the liquid volumes and levels of other channels seemingly unaffected.

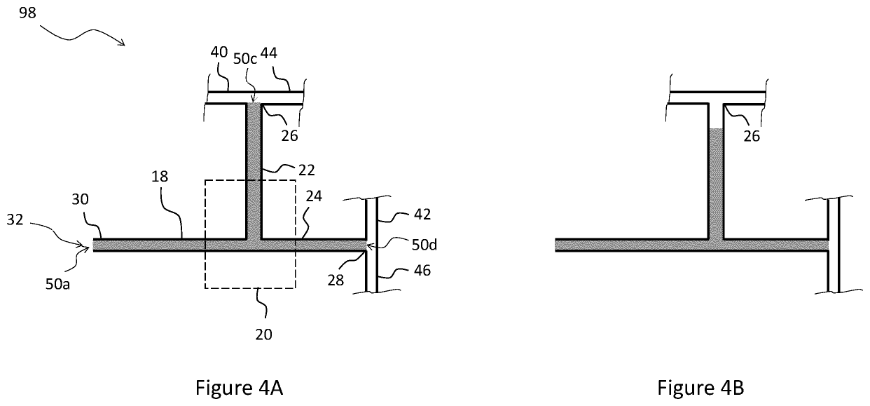

Now turning to FIG. 4A, which illustrates a comparative system 98 lacking the compensating microfluidic channels, but otherwise similar to the system 99 as illustrated in FIGS. 3A and 3B. Also for this comparative system 98 liquid is subjected to evaporation at the liquid-gas interfaces present at the sample inlet 32, and at the first and the second capillary stop valves, as indicated by arrows 50a, 50c, and 50d. Depending on retention capillary pressures of the sample inlet 32, and at the first and the second capillary stop valves 26, 28, air or ambient gas, may enter the system 98 in replacement of evaporated liquid, at sample inlet 32, and at the first and the second capillary stop valves 26, 28. For example, if one of the interfaces stopped at the stop valve of one the outlet channels has the lowest retention capillary pressure of the system 98, that outlet channel may have air or gas penetrating into that outlet channel via the corresponding stop valve. This may result in, for example, malfunctioning of the stop valve such as not allowing the liquid to flow out from that channel as the valve is attempted to be triggered, or, for example, air bubbles may flow out from that channel and proceeding further into or out of the system 98, resulting for example in tempering with downstream analysis. Alternative, for example, air or gas may enter at the sample inlet 32, which may result in other disadvantages. One example of a possible result with this comparative system 98 is illustrated in FIG. 4B, where air is present adjacent to stop valve 26. Thus, based on above discussions, benefits with examples of present embodiments comprising the compensating microfluidic channel 10 shall be appreciated.

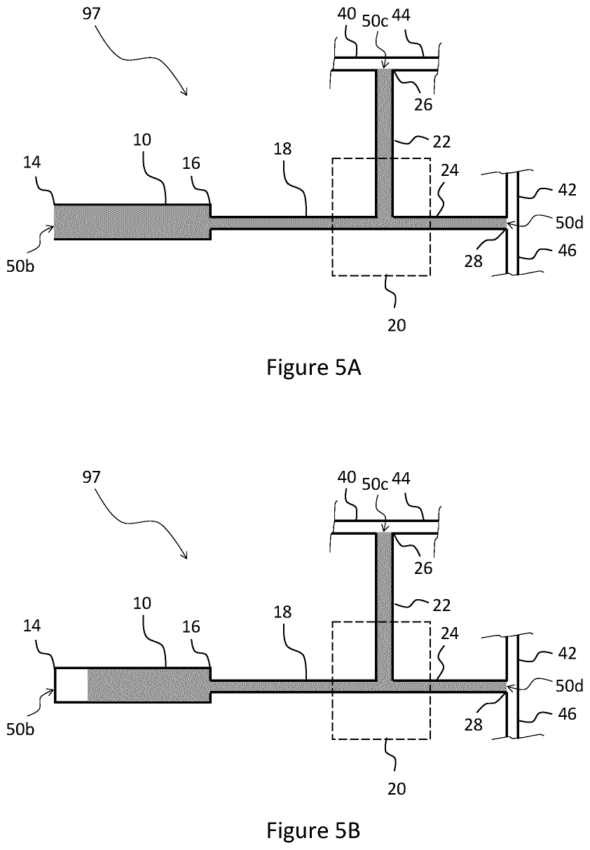

With reference to FIGS. 5A and 5B, a microfluidic system 97 according to another exemplary embodiment will be discussed in the following. The microfluidic system 97 is illustrated as filled with liquid schematically illustrated as grey fields. The compensating microfluidic channel 10 is illustrated together with the first end 14, which first end 14 acts as a sample inlet. Similar to what has been described with reference to FIG. 3A, the liquid has via capillary action, via the inlet and the first microfluidic channel 18, entered the sample manipulation portion and the first outlet microfluidic channels 22 ending in a first stop valve 26; and the second outlet microfluidic channels 24 ending in a second stop valve 28. The first and second stop valves 26, 28 may, optionally, be trigger valves, for example, capillary trigger valves as previously described. The liquid is subjected to evaporation at the liquid-gas interfaces present at the sample inlet at the first end 14 of the compensating microfluidic flow channel, and at the first and the second capillary stop valves, as indicated by arrows 50b to 50d. Evaporation from the first and the second capillary stop valves 26 and 28, will not result in air entering from the ambiance at any of those interfaces as the retention capillary pressures there are higher than the retention capillary pressure in the compensating channel. Instead, liquid evaporated therefrom will be compensated via liquid provided from the compensating channel. Air will therefore enter the compensating microfluidic channel at the first end 14. FIG. 5B illustrates the system 97 as it may appear after a while of evaporation. Liquid volume has dropped in compensating microfluidic channel 10 while leaving the liquid volumes and levels of other channels appearingly unaffected.

The comparative system 98 illustrated and discussed with reference to FIGS. 4A and 4B may be discussed as a comparative example also concerning the exemplary embodiments discussed with reference to FIGS. 5A and 5B, to which FIGS. 4A and 4B with appending discussions we hereby refer. In conclusion, based on above discussions concerning exemplary embodiments with reference to FIG. 5A and 5B, benefits with examples of present embodiments comprising the compensating microfluidic channel 10 having a sample inlet shall be appreciated.

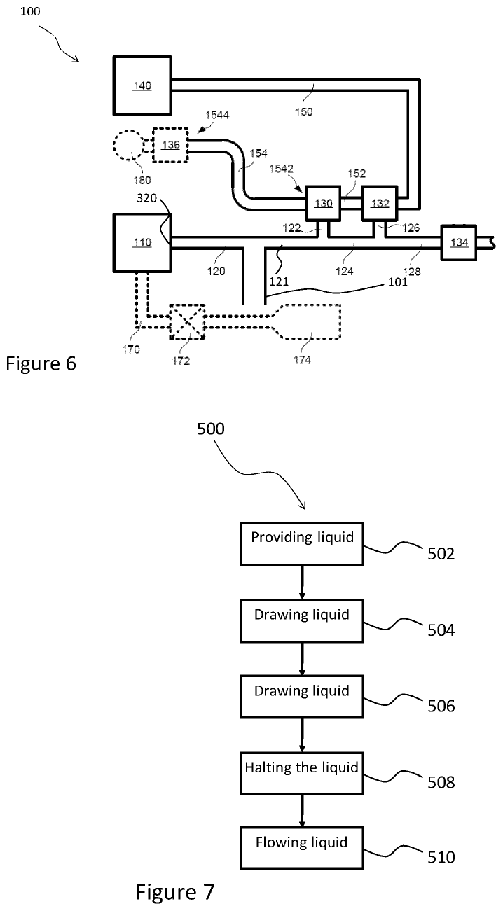

With reference to FIG. 6 one embodiment of the first aspect will now be discussed. The microfluidic system 100 may further comprise a sample reservoir 110 arranged for receiving a sample liquid connected to the sample inlet 320 of the second microfluidic channel 120, the second microfluidic channel 120 branching off into the the compensating microfluidic channel 101 and the first microfluidic channel 121, wherein the first microfluidic channel 121 branches of into a first outlet channel 122 ending in a first stop valve 130, and into a second outlet channel 126 ending in a second stop valve 132. Further illustrated is a third outlet channel 128 ending in a third stop valve 134. In this example, the third outlet channel 128 has a predetermined volume, in which a sample volume having predetermined sample volume may be isolated, by means of the illustrated system 100. The system 100 further comprises a buffer reservoir 140 arranged for receiving a buffer fluid; a first trigger channel 150 arranged to connect the buffer reservoir 140, 240 to the second stop valve 132; a second trigger channel 152 connecting the second stop valve 132 and the first stop valve 130; and an exit channel 154 having a first end 1542 and a second end 1544, wherein the first end 1542 is connected to the first valve 130, wherein the second microfluidic channel 120 is arranged to draw sample fluid from the sample reservoir 110 into the system 100. Optional capillary pump device 174, connected to sample reservoir 110 via channel 170 and flow resistor 172, may act in emptying sample reservoir 110, thereby allowing it to act as a stop valve for second microfluidic channel 120 by providing a gaseous interface with liquid in the second microfluidic channel 120 at, or adjacent to, sample inlet 320. Capillary pump device 174 may, for example, be of a paper pump type. Further illustrated is optional vent 180 and valve 136, which may assist in venting air, for example when liquid flows in the system 100, in particular in exit channel 154. The example illustrates that the microfluidic system according to embodiments or examples may be part a larger device or system. It further illustrates that the stop valves may be integral parts of a system or device, and the outlet channels may connect to other parts of a system or device, eg. other channels, via the stop valves, which may be, for example, trigger valves. Such trigger valves may hold the liquid within the outlet channels for a period of time, such as with the system 100 illustrated with reference to FIG. 6, before being triggered, which triggering requires or at least benefits from that evaporation during the period of time from the stop valves does not result in air entering the outlet channels. With the illustrated system, any evaporation from stop valves 130, 132, 134 will be compensated for by the compensating microfluidic channel 101, by designing the system such that retention capillary pressures at stop valves 130, 132, 134 and retention capillary pressure of the compensating channel relates to each other as has been described with reference to other examples described herein. As an alternative to positioning the compensating microfluidic channel 101 as branched off from the second microfluidic channel 120, it may be positioned in the fluidic pathway between the sample reservoir 110 and the second microfluidic channel 120, or replace the second microfluidic channel 120.

With reference to FIG. 7, a method 500 for compensating evaporation of liquid from channels in a microfluidic system will now be described. The method may be implemented using a microfluidic system according to the first aspect and embodiments thereof, and references are made to the first aspect and embodiments thereof. The method 500 comprises:
providing liquid 502 to a sample inlet 32 of a second microfluidic channel 30, whereby the second microfluidic channel 30 draws liquid, by capillary action, from the sample inlet 32 to fill the second microfluidic channel 30,
drawing liquid 504, by capillary action, from the second microfluidic channel 30 into a compensating microfluidic channel 10 and a first microfluidic channel 18, the compensating microfluidic channel 10 and the first microfluidic channel 18 branching off from the second microfluidic channel 30,
drawing liquid 506, by capillary action, from the first microfluidic channel into a plurality of outlet channels 22, 24 of a sample manipulation portion 20, wherein each outlet channel 22, 24 ends in a respective stop valve 26, 28,
halting the liquid 508 at the respective stop valve 26, 28,
wherein the compensating microfluidic channel 10 exerts a retention capillary pressure on the liquid, and wherein each outlet channel 22, 24 of the plurality of outlet channels 22, 24 exerts a retention capillary pressure on the liquid, each retention capillary pressure of the plurality of outlet channels 22, 24 being larger than the retention capillary pressure of the compensating microfluidic channel 10, and
flowing liquid 510 from the compensating microfluidic channel 10 towards the sample manipulation portion 20 in response to liquid evaporating from one or more of the plurality of outlet channels 22, 24 at the respective stop valve 26, 28, thereby compensating for evaporation of the liquid from the plurality of outlet channels 22, 24 at the respective stop valve 26, 28.

The second microfluidic channel 30 may exert a first retention capillary pressure on the liquid, and the first retention capillary pressure may be larger than the retention capillary pressure of the compensating microfluidic channel 10, wherein the method further may comprise flowing liquid from the compensating microfluidic channel 10 towards the second microfluidic channel 30 in response to liquid evaporating from the sample inlet 32, thereby compensating for evaporation of the liquid from the second microfluidic channel 30 at the sample inlet 32.

It shall be realized and appreciated, that the term outlet microfluidic channel as used herein refers to liquid being outlet from the sample manipulation portion (20), for example, as described in examples herein, but that the liquid may proceed to further manipulation or treatment, eg. analysis, or may be eg. discarded, or forwarded to an additional system.

The stop valves may be trigger valves, for example capillary trigger valves. Trigger valves may be understood as microfluidic structures comprising a fluidic junction of channels where a liquid flow from one channel is stopped at the junction and later may be triggered to flow by a liquid flow reaching the trigger valve or junction from another channel connected to the junction. The liquid flow from the one channel may be stopped at the junction for example, by having its outlet of the junction on the side wall of the another channel, which another channel is deeper than the one channel at the junction.

1. A microfluidic system (1) for compensation of evaporation of liquid from channels, the system comprising:
a compensating microfluidic channel (10, 101) having a first end (14) arranged for hindering capillary driven flow of a liquid out from the compensation microfluidic channel (10) via the first end (14), and, a second end (16), being connected to a first microfluidic channel (18),
a sample manipulation portion (20) comprising a plurality of outlet channels (22, 24),
wherein each outlet channel (22, 24) ends in a respective stop valve (26, 28),
wherein the first microfluidic channel (18) connects to the sample manipulation portion (20), thereby being in fluidic connection with the plurality of outlet channels (22, 24),
wherein each outlet channel (22, 24) of the plurality of outlet channels (22, 24) is arranged to exert a retention capillary pressure on the liquid, and
the compensating microfluidic channel (10) is arranged to exert a retention capillary pressure on the liquid,
wherein the retention capillary pressure of each outlet channel (22, 24) is larger than the retention capillary pressure of the compensating microfluidic channel, such that the liquid flows from the compensating microfluidic channel (10) towards the sample manipulation portion (20) if liquid evaporates from one or more of the plurality of outlet channels (22, 24) at the respective stop valve (26, 28), thereby compensating for evaporation of the liquid from the plurality of outlet channels (22, 24) at the respective stop valve (26, 28).

2. A microfluidic system (1) according to claim 1, wherein the first end (14) of the compensating microfluidic channel (10, 101) is connected to a capillary stop valve, thereby arranged for hindering capillary driven flow of a liquid out from the compensation microfluidic channel (10) via the first end (14).

3. A microfluidic system (1) according to claim 1, further comprising a second microfluidic channel (30) comprising a sample inlet (32) arranged for introduction of sample liquid into the second microfluidic channel (30) and for hindering capillary driven flow of liquid out from the second microfluidic channel (30) via the sample inlet (32), the second microfluidic channel (30) branching off into the compensating microfluidic channel (10) and the first microfluidic channel (18).

4. A microfluidic system (1) according to claim 3, wherein the sample inlet (32) is connected to a capillary stop valve, or another non capillary pressure generating portion, thereby arranged for hindering capillary driven flow of a liquid out from the second microfluidic channel (30) via the sample inlet (32).

5. A microfluidic system (1) according to claim 1, wherein the compensating microfluidic channel comprises a sample inlet at the first end.

6. A microfluidic system according to claim 3, wherein the second microfluidic channel is arranged to exert a first retention capillary pressure on the liquid, and
wherein the first retention capillary pressure is larger than the retention capillary pressure of the compensating microfluidic channel, such that the liquid flows from the compensating microfluidic channel towards the second microfluidic channel if the liquid evaporates from the sample inlet, thereby compensating for evaporation of the liquid from the second microfluidic channel at the sample inlet.

7. A microfluidic system according to claim 1, wherein the plurality of outlet channels comprises a first outlet microfluidic channel ending in a first stop valve, and a second outlet microfluidic channel ending in a second stop valve;
wherein the first outlet microfluidic channel is arranged to exert a second retention capillary pressure on the liquid,
wherein the second outlet microfluidic channel is arranged to exert a third retention capillary pressure on the liquid,
wherein the second capillary pressure is larger than the retention capillary pressure of the compensating microfluidic channel, such that the liquid flows from the compensating microfluidic channel towards the first outlet microfluidic channel, if liquid evaporates from the first outlet microfluidic channels at the first stop valve, thereby compensating for evaporation of the liquid in the first outlet microfluidic channel at the first stop valve, and
wherein the third capillary pressure is larger than the retention capillary pressure of the compensating microfluidic channel, such that the liquid flows from the compensating microfluidic channel towards the second outlet microfluidic channel, if liquid evaporates from the second outlet microfluidic channels at the second stop valve, thereby compensating for evaporation of the liquid in the second outlet microfluidic channel at the second stop valve.

8. A microfluidic system according to claim 1, wherein a cross sectional area of the compensating microfluidic channel is between 1.1 and 4.0 times larger than a cross sectional area of the first outlet microfluidic channel adjacent to the first stop valve, and
wherein a cross sectional area of the compensating microfluidic channel is between 1.1 and 4.0 times larger than the cross sectional area of the second outlet microfluidic channel adjacent to the second stop valve.

9. A microfluidic system according to claim 3, further comprising a sample reservoir arranged for receiving sample fluid,
wherein the sample reservoir is connected to the sample inlet.

10. A microfluidic system according to claim 1, wherein the compensating microfluidic channel is made of a first material, the first outlet microfluidic channel is made of a second material, and the second outlet microfluidic channel is made of the second material.

11. A diagnostic device comprising the microfluidic system of claim 1.

12. The diagnostic device according to claim 11, wherein the diagnostic device is arranged to analyse the sample liquid.

13. A method (500) for compensating evaporation of liquid from channels in a microfluidic system, the method (500) comprising:
providing liquid (502) to a sample inlet (32) of a second microfluidic channel (30), whereby the second microfluidic channel (30) draws liquid, by capillary action, from the sample inlet (32) to fill the second microfluidic channel (30),
drawing liquid (504), by capillary action, from the second microfluidic channel (30) into a compensating microfluidic channel (10) and a first microfluidic channel (18), the compensating microfluidic channel (10) and the first microfluidic channel (18) branching off from the second microfluidic channel (30),
drawing liquid (506), by capillary action, from the first microfluidic channel into a plurality of outlet channels (22, 24) of a sample manipulation portion (20), wherein each outlet channel (22, 24) ends in a respective stop valve (26, 28),
halting the liquid (508) at the respective stop valve (26, 28),
wherein the compensating microfluidic channel (10) exerts a retention capillary pressure on the liquid, and wherein each outlet channel (22, 24) of the plurality of outlet channels (22, 24) exerts a retention capillary pressure on the liquid, each retention capillary pressure of the plurality of outlet channels (22, 24) being larger than the retention capillary pressure of the compensating microfluidic channel (10), and
flowing liquid (510) from the compensating microfluidic channel (10) towards the sample manipulation portion (20) in response to liquid evaporating from one or more of the plurality of outlet channels (22, 24) at the respective stop valve (26, 28), thereby compensating for evaporation of the liquid from the plurality of outlet channels (22, 24) at the respective stop valve (26, 28).

14. A method for compensating evaporation of liquid from channels in a microfluidic system according to claim 13,
wherein
the second microfluidic channel (30) exerts a first retention capillary pressure on the liquid, and
the first retention capillary pressure is larger than the retention capillary pressure of the compensating microfluidic channel (10),
and wherein the method further comprises flowing liquid from the compensating microfluidic channel (10) towards the second microfluidic channel (30) in response to liquid evaporating from the sample inlet (32), thereby compensating for evaporation of the liquid from the second microfluidic channel (30) at the sample inlet (32).
